(19) United States
(12) Patent Application Publication
(10) Pub. No.: US 2012/0173431 A1
(43) Pub. Date: Jul. 5, 2012

(54) SYSTEMS AND METHODS FOR USING A TOKEN AS A PAYMENT IN A TRANSACTION

(75) Inventors: Ben Ritchie, Richmond, TX (US); Tom Sonby, Spring, TX (US); Charles Williams, Houston, TX (US); Reggie Mitchell, Pearland, TX (US); Matthew Webster, Richmond, TX (US); Gerald Daniels, Houston, TX (US)

(73) Assignee: FIRST DATA CORPORATION, Greenwood Village, CO (US)

(21) Appl. No.: 12/982,455

(22) Filed: Dec. 30, 2010

(51) Int. Cl. G06Q 20/00

(52) U.S. Cl. 705/65

(57) ABSTRACT

Embodiments of the invention relate to systems and methods for using a token as a payment in a transaction. In one embodiment, a method for facilitating a payment transaction using a mobile device can be provided. The method can include validating a user's identity; providing a token to the user; receiving the token and user identification information from a merchant as payment for a transaction; and authorizing the transaction.

### TECHNICAL FIELD

The invention relates generally to payment transactions, and more particularly to systems and methods for using a token as a payment in a transaction.

### BACKGROUND OF THE INVENTION

Payments for retail transactions can be made using any number and combination of conventional monies, credit cards, debit cards, smart cards, and contactless devices. In certain instances, authentication of the consumer and security of the transaction may be compromised due to inherent weaknesses in conventional authentication and security processes.

For example, a consumer using a debit card and PIN (personal identification number) may compromise the security of a transaction in the event he or she loses possession of the debit card and the PIN becomes known to an unauthorized user. In another example, security of a transaction may be compromised merely by the loss of possession of a credit card, and an unauthorized user uses the credit card in a transaction.

### SUMMARY OF THE INVENTION

Embodiments of the invention can provide some or all of the above needs. Certain embodiments of the invention can provide systems and methods for using a token as a payment in a transaction, such as at a retail location or online. Certain other embodiments can provide systems and methods for facilitating a payment transaction, such as by using a mobile device, a contactless transaction device, and/or a client device. Certain other embodiments can provide systems and methods for making a payment.

In one embodiment, a method for facilitating a payment transaction using a mobile device can be provided. The method can include validating a user's identity; providing a token to the user; receiving the token and user identification information from a merchant as payment for a transaction; and authorizing the transaction.

In one aspect of an embodiment, validating a user's identity can include receiving the user identification information and payment account information validating the user identification information and payment account by confirming the user is associated with the user identification information and the payment account, and generating a token to provide to the user for a payment transaction.

In one aspect of an embodiment, validating a user's identity can include receiving an online registration request from the user, transmitting a message to the user to complete the online registration, and receiving an indication the user has completed online registration.

In one aspect of an embodiment, validating a user's identity can include receiving a payment account number of the user, facilitating one or more deposits in the user's payment account, and receiving an indication the user has confirmed receipt of the deposit amounts.

In one aspect of an embodiment, validating a user's identity can include transmitting a message to the user, and receiving an indication the user has received the message.

In one aspect of an embodiment, the token can include a unique number for use in a single transaction, a time sensitive code, a numeric string, an alphanumeric string, a single use code, a 2D or 3D bar code, or a unique code.

In one aspect of an embodiment, providing a token to the user can include transmitting the token to the user by at least one of the following: an electronic message, text, tweet, email, online communication, an online communication via HTTP, an online communication via an online communication protocol, a website and/or webpage posting, voice mail, phone call, mail, voice communication, or electronic communication.

In one aspect of an embodiment, providing a token to the user can include storing the token in a data storage device associated with the user.

In one aspect of an embodiment, authorizing the transaction can include decrypting or translating the token to obtain the user's payment account information.

In one aspect of an embodiment, the method can include settling the transaction.

In another embodiment, a system for facilitating a payment transaction using a mobile device can be provided. The system can include at least one data storage device operable to store computer-readable instructions; at least one computer processor operable to execute the computer-readable instructions; and a set of computer-readable instructions. The set of computer-readable instructions can be operable to validate a user's identity; provide a token to the user; receive the token and a user identification information from a merchant as payment for a transaction; and authorize the transaction.

In one aspect of an embodiment, the computer-readable instructions operable to validate a user's identity can further include computer-readable instructions operable to receive the user identification information and payment account information; validate the user identification information and payment account number by confirming the user is associated with the user identification information and a payment account; and generate a token to provide to the user for a payment transaction.

In one aspect of an embodiment, the computer-readable instructions operable to validate a user's identity can include computer-readable instructions operable to receive an online registration request from the user; transmit a message to the user to complete the online registration; and receive an indication the user has completed online registration.

In one aspect of an embodiment, the computer-readable instructions operable to validate a user's identity can include computer-readable instructions operable to receive a payment account number of the user; facilitate one or more deposits in the user's payment account; and receive an indication the user has confirmed receipt of the deposit amounts.

In one aspect of an embodiment, the computer-readable instructions can be further operable to transmit a message to the user; and receive an indication the user has received the message.

In one aspect of an embodiment, the token can include a unique number for use in a single transaction, a time sensitive code, a numeric string, an alphanumeric string, a single use code, a 2D or 3D bar code, or a unique code.

In one aspect of an embodiment, the computer-readable instructions operable to provide a token to the user can include computer-readable instructions operable to transmit the token to the user by at least one of the following: an electronic message, text, tweet, email, online communication, an online communication via HTTP, an online communication via an online communication protocol, a website and/or webpage posting, voice mail, phone call, mail, voice communication, or electronic communication.

In one aspect of an embodiment, the computer-readable instructions operable to provide a token to the user can include computer-readable instructions operable to store the token in a data storage device associated with the user.

In one aspect of an embodiment, the computer-readable instructions operable to authorize the transaction can include computer-readable instructions operable to decrypt or translate the token to obtain the user's payment account.

In one aspect of an embodiment, the computer-readable instructions can be further operable to settle the transaction.

In yet another embodiment, a method for facilitating a payment transaction can be provided. The method can include receiving a token and user identification information from a customer as payment for a transaction; transmitting the token and the user identification information to a trusted third party; receiving an indication whether the transaction is authorized; if the transaction is authorized, receiving electronic funds from the trusted third party; and if the transaction is not authorized, informing the customer the transaction is declined.

In one aspect of an embodiment, receiving a token and user identification information from a customer as payment for a transaction can include receiving the customer's token transaction command in a merchant client transaction device terminal, and receiving the customer's input of at least the token to the merchant client transaction device with or without a PIN.

In one aspect of an embodiment, receiving a token and user identification information from a customer as payment for a transaction can include receiving an indication of the customer's manipulation of a data storage device adjacent to a near field communication (NFC) device.

In one aspect of an embodiment, receiving a token and user identification information from a customer as payment for a transaction can include receiving the token from the customer, inputting the token in a payment terminal, and transmitting the token to a trusted third party.

In yet another embodiment, a method for making a payment can be provided. The method can include providing user identification information and payment account information to a trusted third party; transmitting an indication in response to instructions to confirm an identity; receiving a token for making a payment to a merchant; and providing the token to a merchant as payment for a transaction.

In one aspect of an embodiment, providing user identification information and payment account information to a trusted third party can include transmitting an online registration request to the trusted third party.

In one aspect of an embodiment, transmitting an indication in response to instructions to confirm an identity can include receiving an indication of one or more deposits in the customer's payment account, and transmitting an indication confirming receipt of the deposit amounts.

In one aspect of an embodiment, transmitting an indication in response to instructions to confirm an identity can include transmitting a message to the trusted third party in response to receiving a message from the trusted third party.

In one aspect of an embodiment, the token can include a unique number for use in a single transaction, a time sensitive code, a numeric string, an alphanumeric string, a single use code, a 2D or 3D bar code, or a unique code.

In one aspect of an embodiment, receiving a token for making a payment to a merchant can include receiving the token by at least one of the following: an electronic message, text, tweet, email, online communication, an online communication via HTTP, an online communication via an online communication protocol, a website and/or webpage posting, voice mail, phone call, mail, voice communication, or electronic communication.

In one aspect of an embodiment, receiving a token for making a payment to a merchant can include storing the token in a data storage device associated with the customer.

In one aspect of an embodiment, providing the token to a merchant as payment for a transaction can include entering a token transaction command in a merchant client transaction device, and inputting at least the token to the merchant client transaction device with or without a PIN.

In one aspect of an embodiment, providing the token to a merchant as payment for a transaction can include manipulating a data storage device adjacent to a near field communication (NFC) device.

In one aspect of an embodiment, providing the token to a merchant as payment for a transaction can include providing the token to the merchant to input to a payment terminal for transmission to a trusted third party.

Other systems and processes according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates an example functional block diagram of an example system, according to one embodiment of the invention;

FIG. 2 illustrates an example data flow of an example system and method, according to one embodiment of the invention;

FIG. 3 illustrates an example flowchart of an example method, according to one embodiment of the invention; and

FIG. 4 illustrates an example flowchart of an example method, according to one embodiment of the invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the term “token” and its pluralized form can include a unique code for use in a transaction to purchase a good and/or service. Example tokens can include, but are not limited to, a unique number for use in a single transaction, a time sensitive code, a numeric string, an alphanumeric string, a single use code, a 2D or 3D bar code, or a unique code.

As used herein the terms “merchant” and “merchant user” are used interchangeably and refer to a person and/or entity, who may receive a token as payment for a purchase of a good and/or service.

As used herein the terms “consumer,” “user,” and “customer” are used interchangeably, and refer to a person and/or entity desiring to use a token for a purchase of a good and/or service from a merchant or merchant user.

Certain embodiments of the invention generally provide for systems and methods for using a token as a payment in a transaction, such as at a retail location or online. Certain other embodiments can provide systems and methods for facilitating a payment transaction, such as by using a mobile device, a contactless device, and/or a client device. Certain other embodiments can provide systems and methods for making a payment.

Certain embodiments of systems and methods described herein can provide a technical effect and/or competitive feature to enhance or improve the security of payment transactions by consumers using mobile devices, contactless cards and devices, client devices, computers, and other processor-based or memory-based devices. One other technical effect and/or competitive feature of systems and methods described herein is that secure transactions can be processed faster and more conveniently than conventional secure transactions. Another technical effect and/or competitive feature of systems and methods described herein is that certain pre-existing transaction processing components and processes already used to process a variety of credit, debit, stored value card, loyalty reward, gift card, and/or coupon redemption transactions can be leveraged to accept a token in a payment transaction with little or no modification to the pre-existing components and processes.

### Token Payment Processing System

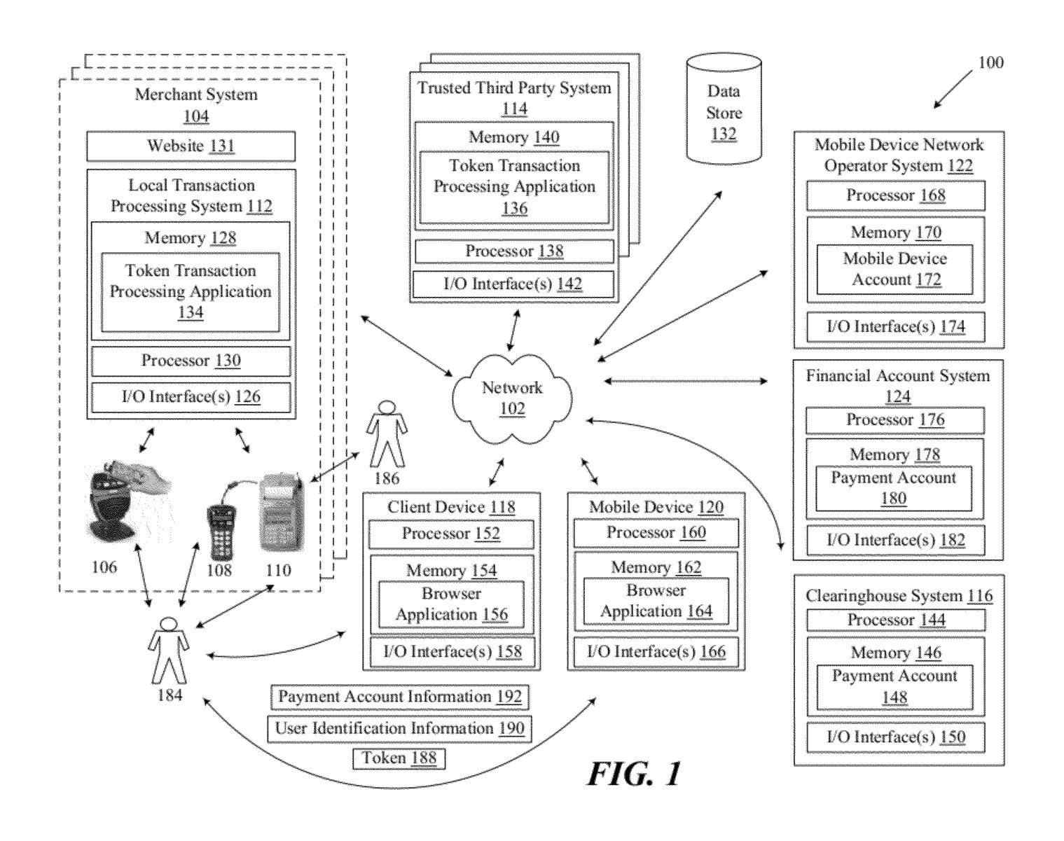

FIG. 1 illustrates an example environment and system in accordance with an embodiment of the invention. In this example, the environment can be a client-server configuration, and the system can be a token payment processing system 100. The system 100 is shown with a communications network 102, such as the Internet and/or a telephone network, in communication with one or more merchant systems 104 and/or local transaction processing systems 112, which can include any number of associated merchant transaction client devices equipped with a contactless transaction card reader or card reader functionality, such as a contactless transaction device 106, PIN pad 108, transaction terminal 110, point of sale (POS) terminal, a 2D and/or 3D bar code reader, a voice or tone microphone, a magnetic card reader, a wireless transceiver, personal computer, or other telecommunications devices. The merchant transaction client devices 106, 108, 110, which are shown by example only, can typically be administered by respective merchants or associated merchant systems 104 and/or local transaction processing systems 112.

The system 100 can include at least one trusted third party system 114, such as may be operated by or on behalf of one or more trusted parties, third party payment processors, or account program managers. Further, the system 100 can be in communication with at least one clearinghouse system 116, such as an issuing bank or merchant bank.

Furthermore, the system 100 can be operable to communicate with any number of client devices, such as 118, and mobile devices, such as 120. Example client devices can include, but are not limited to, personal computers, desktop computers, laptop computers, Internet appliances, netbook computers, touchpad computing devices, handheld portable computers, digital assistants, personal digital assistants, cellular phones, mobile phones, smart phones, pagers, digital tablets, and other processor-based computer devices. Example mobile devices can include, but are not limited to, laptop computers, Internet appliances, netbook computers, touchpad computing devices, handheld portable computers, digital assistants, personal digital assistants, cellular phones, mobile phones, smart phones, pagers, digital tablets, and other portable processor-based computer devices.

In certain embodiments, the system 100 can also be in communication with a mobile device network operator system 122, such as a mobile phone carrier network. In certain other embodiments, the system 100 can also be in communication with a financial account system 124, such as a bank, credit union, or loyalty rewards program.

It will be appreciated that while the disclosure may in certain instances describe only a single merchant system 104, local transaction processing system 112, trusted third party system 114, clearinghouse system 116, client device 118, mobile device 120, mobile device network operator system 122, financial account system 124; there may be multiple merchant systems, local transaction processing systems, trusted third party systems, clearinghouse systems, client devices, mobile devices, mobile device network operator systems, and/or financial account systems; without departing from example embodiments of the invention.

The communications network 102 shown in FIG. 1 may include any telecommunication and/or data network, whether public, private, or a combination thereof, including a local area network, a wide area network, an intranet, an internet, the Internet, intermediate hand-held data transfer devices, a publicly switched telephone network (“PSTN”), a cellular network, and/or any combination thereof and may be wired and/or wireless. The network 102 may also allow for real-time, off-line, and/or batch transactions to be transmitted between or among the merchant systems 104, local transaction processing system 112, trusted third party system 114, clearinghouse system 116, client device 118, mobile device 120, mobile device network operator system 122, and financial account system 124. Due to network connectivity, various methodologies as described herein may be practiced in the context of distributed computing environments. It will also be appreciated that the network 102 may include a plurality of networks, each with devices such as gateways and routers for providing connectivity between or among networks. Instead of, or in addition to, a network 102, dedicated communication links may be used to connect the various devices and/or system components in accordance with an example embodiment invention. For example, the local transaction processing system 112 and trusted third party system 114 may form the basis of network 102 that interconnects any number of the merchant systems 104, clearinghouse systems 116, client devices 118, mobile devices 120, mobile device network operator systems 122, and financial account systems 124.

The one or more merchant systems 104 can be one or more systems at any merchant, such as a retailer or a services provider, for processing consumer transactions. The merchant systems 104 may include at least one of the merchant transaction client devices shown as 106, 108, and 110. In other embodiments, the merchant systems 104 may include a POS transaction terminal for capturing transaction information, for interfacing with a cash register, for displaying information to a terminal operator and/or a consumer, and for processing transactions with an account processor, such as a trusted third party system 114. Example consumer transactions that may be processed by a merchant system 104 may include, but are not limited to, purchasing, payment, account inquiry, account activation, loading, and reloading transactions.

A merchant system 104 can include one or more computer or processor-based devices capable of communicating with the communications network 102 via a signal, such as a wireless frequency signal or a direct wired communication signal. In at least one embodiment, more than one merchant system 104 can be in communication with the communications network 102 to transmit and receive communications between other devices and/or system components. The merchant systems 104 can include or otherwise be associated with a processor and a computer-readable medium, such as RAM, ROM, and/or a removable storage device. Merchant systems 104 may operate on any operating system capable of supporting an application program including, but not limited to, Microsoft Windows®, Apple OSX™, and Linux. In one embodiment, the merchant system 104 may include computer executable program instructions stored in memory for processing consumer transactions within the merchant system 104 and with other back-end account processors, such as the trusted third party system 114 and/or any other clearinghouse systems 116, or third-party service providers. The merchant system 104 can also include one or more I/O interface(s), such as 126, to facilitate communication via the network 102 with one or more other components of the system 100, such as, with one or more merchant transaction client devices 106, 108, 110, one or more local transaction processing systems 112, one or more trusted third party systems 114, one or more clearinghouse systems 116, one or more client devices 118, one or more mobile devices 120, one or more mobile device network operator systems 122, and/or one or more financial account systems 124. According to one example embodiment, the merchant system 104 can communicate with the trusted third party system 114 via the one or more networks 102, which may include a proprietary private network, a banking network, such as an ACH network, or a combination thereof, for processing financial and account transactions between the various entities, devices, and/or components of the system 100. POS terminals associated with the merchant system 104 may also include any number of other external or internal devices such as, but not limited to, a card reader, contactless transaction card reader, a magnetic card reader, a RFID reader, a mouse, a CD-ROM, DVD, a keypad, a keyboard, a touchpad, a display, or other input or output devices. In addition to or instead of a conventional POS terminal, a merchant system 104 may include electronic cash registers, electronic kiosks, mobile computers, handheld portable computers, digital assistants, personal digital assistants, cellular phones, mobile phones, smart phones, pagers, digital tablets, personal computers, desktop computers, laptop computers, Internet appliances, netbook computers, touchpad computing devices, handheld portable computers, and other processor-based devices, and/or may be implemented via a web portal or other electronic commerce service.

In one embodiment, a suitable merchant system 104 and associated software can include, but is not limited to, Aloha® EDC Server, Datacap Systems Datatran™, DataVantage® Tradewind®, EMN8® OrderM8™, Exadigm Mate Plus, Hypercom® T4100, IBM® Websphere®, Infogenesis Revelation, Ingenico® Ingepay™, Micros®, Oracle® iPayment, Radiant® Systems Epsilon, Southern Datacomm Protobase®, and VeriFone® Omni™ based systems.

Generally, each merchant system 104 can include a local transaction processing system 112 with a respective memory 128 and processor 130. The memory 128 of the local transaction processing system 112 and/or those associated with the merchant transaction client devices 106, 108, 110 can store data and information for subsequent retrieval. For example, in this embodiment, the memory 128 may be any computer-readable medium, such as RAM, ROM, and/or a removable storage device, coupled to the processor 130. The memory 128 may include an operating system (“OS”), such as, but not limited to, Microsoft Windows®, Apple OSX™, or Linux, and a database management system (“DBMS”) to facilitate management of data files and data stored in the memory 128 and/or stored in a data store, for example. In this manner, the merchant system 104 can store various received or collected information from the merchant transaction client devices 106, 108, 110, trusted third party systems 114, clearinghouse systems 116, client devices 118, mobile devices 120, mobile device network operator systems 122, and/or financial account systems 124. The memories and data stores or databases can be in communication with each other and/or other databases, such as a centralized database, or other types of data storage devices. When needed, data or information stored in a memory or database may be transmitted via the network 102 to a centralized database or data store, such as 132, capable of receiving data, information, or data records from more than one database or other data storage devices. In other embodiments, the data stores or databases shown can be integrated or distributed into any number of databases or data stores.

In one embodiment, the merchant system 104 can host a webpage and/or website, such as 131, to facilitate consumer authentication and registration as well as online purchase transactions. For example, the website 131 can be accessible to one or more consumers browsing a network, such as 102, via a client device, such as 118, or a mobile device, such as 120. In certain embodiments, a merchant system 104 can be associated with a network accessible, server component operable to host a website, such as 131, with one or more webpages for facilitating consumer authentication and registration for obtaining a token for a purchase transaction as well as for online token purchase transactions by one or more consumers.

The merchant transaction client devices 106, 108, 110 may be any processor-based device operable to communicate over a network, such as 102. Example merchant transaction client devices can include, but are not limited to, contactless transaction devices, contactless card transaction devices, PIN pads, transaction terminals, point of sale (POS) terminals, personal computers, mobile computers, handheld portable computers, digital assistants, personal digital assistants, cellular phones, mobile phones, smart phones, pagers, digital tablets, desktop computers, laptop computers, Internet appliance, or any other processor-based device. A respective communication or input/output interface associated with each merchant transaction client device, 106, 108, 110 can facilitate communications between the merchant transaction client device, local transaction processing system 112, and the network 102. Each merchant transaction client device 106, 108, 110 can include a processor and a computer-readable medium, such as a random access memory (“RAM”), read only memory (“ROM”), and/or a removable storage device, coupled to the processor. The processor can execute computer-executable program instructions stored in memory. Merchant transaction client devices 106, 108, 110 may operate on any operating system capable of supporting a browser or browser-enabled application including, but not limited to, Microsoft Windows®, Apple OSX™, and Linux. The merchant transaction client devices 106, 108, 110 may include, for example, personal computers executing a browser application program such as Microsoft Corporation's Internet Explorer™, Netscape Communication Corporation's Netscape Navigator™, and Apple's Safari™, and Mozilla Firefox™. The merchant transaction client devices 106, 108, 110 may also include one or more input/output (“I/O”) interface(s) to facilitate communication with one or more other components of the system 100, such as, with a local transaction processing system 112, one or more merchant systems 104, one or more trusted third party systems 114, one or more clearinghouse systems 116, one or more client devices 118, one or more mobile devices 120, one or more mobile device network operator systems 122, and/or one or more financial account systems 124.

Furthermore, the processor 130 is operable to execute computer-executable program instructions stored in memory 128, which may include a token transaction processing application 134. In this embodiment, the token transaction processing application 134 can operate in conjunction with a token transaction processing application, such as 136, associated with the trusted third party system 114. In certain embodiments, the token transaction processing application 134 may operate alone or in conjunction with other token transaction processing applications located on other devices, servers, and/or client devices.

In any instance, a token transaction processing application, such as 134, can include computer-readable instructions or code operable to facilitate validating a user's identity. Furthermore, a token transaction processing application, such as 134, can include computer-readable instructions or code operable to facilitate providing a token to the user. In addition, a token transaction processing application, such as 134, can include computer-readable instructions or code operable to facilitate receiving the token and user identification information from a merchant as payment for a transaction. Moreover, a token transaction processing application, such as 134, can include computer-readable instructions or code operable to facilitate authorizing the transaction.

In one embodiment, a token transaction processing application, such as 134, can include computer-readable instructions or code operable to facilitate receiving user identification information and payment account information validating the user identification information and payment account by confirming the user is associated with the user identification information and the payment account, and additional computer-readable instructions or code operable to facilitate generating a token to provide to the user for a payment transaction.

In one embodiment, a token transaction processing application, such as 134, can include computer-readable instructions or code operable to facilitate receiving an online registration request from the user, transmitting a message to the user to complete the online registration, and receiving an indication the user has completed online registration.

In one embodiment, a token transaction processing application, such as 134, can include computer-readable instructions or code operable to receive a payment account number of the user, facilitate one or more deposits in the user's payment account, and receive an indication the user has confirmed receipt of the deposit amounts.

In one embodiment, a token transaction processing application, such as 134, can include computer-readable instructions or code operable to facilitate transmitting a message to the user, and receiving an indication the user has received the message.

In one embodiment, a token can include, but is not limited to, a unique number for use in a single transaction, a time sensitive code, a numeric string, an alphanumeric string, a single use code, a 2D or 3D bar code, or a unique code.

In one embodiment, a token transaction processing application, such as 134, can include computer-readable instructions or code operable to facilitate transmitting the token to the user by at least one of the following: message, text, tweet, email, online, an online communication via HTTP, an online communication via an online communication protocol, voice mail, phone call, mail, or other electronic communication.

In one embodiment, a token transaction processing application, such as 134, can include computer-readable instructions or code operable to facilitate storing the token in a data storage device associated with the user.

In one embodiment, a token transaction processing application, such as 134, can include computer-readable instructions or code operable to facilitate decrypting or translating the token to obtain the user's payment account information.

In one embodiment, a token transaction processing application, such as 134, can include computer-readable instructions or code operable to facilitate settling the transaction.

Typically, the local transaction processing system 112 and token transaction processing application 134 are used to facilitate processing a token with any number of payment transactions, such as credit transactions, debit transactions, stored value account transactions, loyalty card transactions, gift card transactions, and coupon transactions, and other purchase and/or redemption transactions as may be performed between a customer and a merchant associated with a merchant system, such as 104. In one embodiment, a local transaction processing system 112 and token transaction processing application 134 may also facilitate performing payment account services for or on behalf of other entities, such as for card issuing financial institutions (which may otherwise be referred to herein as “issuers,” “card issuers,” or “account issuers”). In other embodiments, a local transaction processing system 112 may be a distributed system, and at least some of the functionality described herein with reference to the payment processing system 100 may be performed in a distributed manner by one or more of the other entities and/or components described herein.

It will be appreciated that the local transaction processing system 112 may be implemented on a general purpose computer or may be a specialized machine in which a computer is customized to perform at least the functions of the token transaction processing application 134 according to an example embodiment of the invention.

As mentioned above, the system 100 can include one or more trusted third party systems, such as 114, in communication via the network 102 with any number of merchant systems 104, local transaction processing systems 112, merchant transaction client devices 106, 108, 110, clearinghouse systems 116, client devices 118, mobile devices 120, mobile device network operator systems 122, and financial account systems 124. A trusted third party system, such as 114, may include one or more transaction processing systems, which may include server devices, mainframe computers, networked computers, a processor-based device, or any other suitable processor-based devices for electronically processing token transactions received over a network and communicated between individuals, merchants, financial institutions, employers, and other entities. The trusted third party system 114 shown in FIG. 1 can include at least one processor 138, a memory 140, and one or more I/O interface(s) 142. The memory 140 may be any computer-readable medium, such as RAM, ROM, and/or a removable storage device, coupled to the processor 138. The memory 140 may include an operating system (“OS”), such as, but not limited to, Microsoft Windows®, Apple OSX™, or Linux, and a database management system (“DBMS”) to facilitate management of data files and data stored in the memory 140 and/or stored in a data store 132, for example. The processor 138 is operable to execute computer-executable program instructions stored in memory 140, which may include a token transaction processing application 136. In this embodiment, the token transaction processing application 136 can operate in conjunction with a token transaction processing application, such as 134, associated with the merchant system 104. In certain embodiments, the token transaction processing application 136 may operate alone or in conjunction with other token transaction processing applications located on other devices, servers, and/or client devices. The token transaction processing application 136 can include some or all of the instructions and code similar to the token transaction processing application 134 of the merchant system 104.

The token transaction processing application 136 may additionally operate in conjunction with the one or more I/O interfaces 142 associated with the trusted third party system 114 to facilitate communication with one or more other components of the system 100, such as, with one or more merchant systems 104, one or more transaction client devices such as 106, 108, 110, one or more local transaction processing systems 112, one or more clearinghouse systems 116, one or more client devices 118, one or more mobile devices 120, one or more mobile device network operator systems 122, and/or one or more financial account systems 124. Various example communications a token transaction processing application, such as 136, can facilitate can include, but are not limited to, an electronic message, text, tweet, email, online communication, an online communication via HTTP, an online communication via an online communication protocol, a website and/or webpage posting, voice mail, phone call, mail, voice communication, or electronic communication.

It will be appreciated that the trusted third party system 114 may be implemented on a general purpose computer or may be a specialized machine in which a computer is customized to perform at least the functions of the token transaction processing application 136, according to an example embodiment of the invention.

In other embodiments, the trusted third party system 114 may be a distributed system, and at least some of the functionality described herein with reference to the transaction processing system may be performed in a distributed manner by one or more of the other entities and/or systems described herein.

The one or more clearinghouse systems, such as 116, can be any financial institution operable to provide clearing and settlement services for financial transactions. The clearinghouse system 116 shown in FIG. 1 can include one or more computer or processor-based devices capable of communicating with the communications network 102 via a signal, such as a wireless frequency signal or a direct wired communication signal. In at least one embodiment, more than one clearinghouse systems 116 can be in communication with network 102 to transmit and receive communications between other system components. Similar to the trusted third party system 114, the clearinghouse system 116 can include or otherwise be associated with a processor 144 and a computer-readable medium, such as memory 146, RAM, ROM, and/or a removable storage device. In one embodiment, the clearinghouse system 116 includes computer executable program instructions stored in memory for maintaining, clearing, and settling any number and type of financial accounts, such as a bank account 148, credit account, debit account, stored value account, loyalty reward account, gift card account, and coupon redemption account, and for processing and settling transactions associated therewith. The clearinghouse system 116 can also include one or more I/O interface(s), such as 150, to facilitate communication, for example, over the network 102 with one or more other components of the system 100, such as, with one or more merchant systems 104, one or more merchant transaction client devices 106, 108, 110, one or more local transaction processing systems 112, one or more trusted third party systems 114, one or more client devices 118, one or more mobile devices 120, one or more mobile device network operator systems 122, and/or one or more financial account systems 124. According to one example embodiment, the clearinghouse system 116 can communicate with the trusted third party system 114 via the network 102, which may include a banking network, such as an ACH network, for processing token, financial, and account transactions between the entities of the system 100.

The client device 118 may be any processor-based device operable to communicate over a network, such as 102. Example client devices can include, but are not limited to, personal computers, desktop computers, laptop computers, Internet appliances, netbook computers, touchpad computing devices, handheld portable computers, digital assistants, personal digital assistants, cellular phones, mobile phones, smart phones, pagers, digital tablets, and other processor-based computer devices. The client device 118 can include a processor, such as 152, and a computer-readable medium, such as memory 154, a random access memory (“RAM”), read only memory (“ROM”), and/or a removable storage device, coupled to the processor 152. The processor 152 can execute computer-executable program instructions stored in memory 154. Client device 118 may operate on any operating system capable of supporting a browser or browser-enabled application including, but not limited to, Microsoft Windows®, Apple OSX™, and Linux. The client device 118 may include, for example, personal computers executing a browser application program 156 such as Microsoft Corporation's Internet Explorer™, Netscape Communication Corporation's Netscape Navigator™, and Apple's Safari™, and Mozilla Firefox™. The client device 118 may also include one or more input/output (“I/O”) interface(s), such as 158, to facilitate communication with one or more other components of the system 100, such as, with one or more merchant systems 104, one or more trusted third party systems 114, one or more clearinghouse systems 116, one or more mobile devices 120, one or more mobile device network operator systems 122, and/or one or more financial account systems 124.

The mobile device 120 may be any processor-based device operable to communicate over a network, such as 102. Example mobile devices can include, but are not limited to, laptop computers, Internet appliances, netbook computers, touchpad computing devices, handheld portable computers, digital assistants, personal digital assistants, cellular phones, mobile phones, smart phones, pagers, digital tablets, and other portable processor-based computer devices. The mobile device 120 can include a processor, such as 160, and a computer-readable medium, such as memory 162, a random access memory (“RAM”), read only memory (“ROM”), and/or a removable storage device, coupled to the processor 160. The processor 160 can execute computer-executable program instructions stored in memory 162. Mobile device 120 may operate on any operating system capable of supporting a browser or browser-enabled application including, but not limited to, Microsoft Windows®, Apple OSX™, and Linux. The mobile device 120 may include, for example, personal computers executing a browser application program 164 such as Microsoft Corporation's Internet Explorer™, Netscape Communication Corporation's Netscape Navigator™, and Apple's Safari™, and Mozilla Firefox™. The mobile device 120 may also include one or more input/output (“I/O”) interface(s), such as 166, to facilitate communication with one or more other components of the system 100, such as, with one or more merchant systems 104, one or more local transaction processing systems 112, one or more trusted third party systems 114, one or more clearinghouse systems 116, one or more client devices 118, one or more mobile device network operator systems 122, and/or one or more financial account systems 124.

The one or more mobile device network operator systems, such as 122, can be a telecommunications services or telecommunications network provider. A mobile device network operator system 122 can include one or more computer or processor-based devices capable of communicating with the communications network 102 via a signal, such as a wireless frequency signal or a direct wired communication signal. In at least one embodiment, more than one mobile device network operator system 122 can be in communication with network 102 to transmit and receive communications between other system components. Similar to other system components, the mobile device network operator system 122 can include or otherwise be associated with a processor, such as 168, and a computer-readable medium, such as memory 170, RAM, ROM, and/or a removable storage device. In one embodiment, the mobile device network operator system 122 includes computer executable program instructions stored in memory 170 for maintaining mobile device accounts, such as a consumer account for operating a mobile device on a network or mobile device account 172, and for processing and settling transactions associated therewith. The mobile device network operator system 122 can also include one or more I/O interface(s), such as 174, to facilitate communication, for example, over the network 102 with one or more other components of the system 100, such as, with one or more merchant systems 104, one or more merchant transaction client devices 106, 108, 110, one or more local transaction processing systems 112, one or more trusted third party systems 114, one or more clearinghouse systems 116, one or more client devices 118, one or more mobile devices 120, and/or one or more financial account systems 124. According to one example embodiment, the financial institution system 116 can communicate with the server transaction processing system 114 via the one or more networks 102, which may include a banking network, such as an ACH network, for processing token, financial, and account transactions between the entities of the system 100.

The one or more financial account systems, such as 124, can be any financial institution, such as an issuing bank for credit accounts, debit accounts, stored value accounts, loyalty rewards accounts, coupon redemption accounts; a merchant bank; an employer bank; and/or a processor bank. A financial account system 124 can include one or more computer or processor-based devices capable of communicating with the network 102 via a signal, such as a wireless frequency signal or a direct wired communication signal. In at least one embodiment, more than one financial account system 124 can be in communication with network 102 to transmit and receive communications between other system components. Similar to the other system components, the financial account system 124 can include or otherwise be associated with a processor, such as 176, and a computer-readable medium, such as memory 178, RAM, ROM, and/or a removable storage device. In one embodiment, the financial account system 124 includes computer executable program instructions stored in memory 178 for maintaining financial accounts, such as a payment account 180, credit account, debit account, stored value account, loyalty reward account, gift card account, and coupon redemption account, and for processing and settling transactions associated therewith. The financial account system 124 can also include one or more I/O interface(s), such as 182, to facilitate communication with one or more other components of the system 100, for example, over the network 102 with one or more other components of the system 100, such as, with one or more merchant systems 104, one or more merchant transaction client devices 106, 108, 110, one or more local transaction processing systems 112, one or more trusted third party systems 114, one or more clearinghouse systems 116, one or more client devices 118, one or more mobile devices 120, and/or one or more mobile device network operator systems 122. According to one example embodiment, the financial account system 124 can communicate with the trusted third party system 114 via the network 102, which may include a banking network, such as an ACH network, for processing token, financial, and account transactions between the entities of the system 100.

Suitable processors for a merchant system 104, merchant transaction client devices 106, 108, 110, local transaction processing system 112, trusted third party system 114, clearinghouse system 116, client device 118, mobile device 120, mobile device network operator system 122, and/or financial account system 124 may comprise a microprocessor, an ASIC, and state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processor 128 of the local transaction processor system 112, or any other processors, for example those used by the client devices 106, 108, 110, server transaction processing system 114, financial institution system 116, client device 118, mobile device 120, mobile device network operator system 122, and/or financial account system 124, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

### Authentication and Registration Processes for a Token Transaction

In the system 100 illustrated in FIG. 1, a consumer 184 may interact with a client device, such as 118, and/or a mobile device, such as 120, to obtain a token for use as payment for a purchase of goods and/or services. When obtained and used in a purchase transaction, a token, such as 188, can enhance or improve the security of payment transactions by consumers using mobile devices, contactless cards and devices, computers, and other processor-based or memory-based devices. Furthermore, relatively secure transactions can be processed faster and more conveniently than conventional secure transactions.

In one embodiment, a consumer 184 may register with the system 100 during an online session via a client device, such as 118. Using a browser application 162 to communicate via the network 102, the consumer 184 can interact with a website and/or webpage hosted or associated with a merchant system, such as 104, or a trusted third party system, such as 114. During the communication, the consumer 184 may provide, upon request, certain information to the trusted third party system 114. In another embodiment, a consumer may register with the system 100 during an online session via a mobile device, such as 120. For example, an application program or app on the mobile phone 120 may initiate a communication via the network 102 with the trusted third party system 114. By way of further example, the consumer 184 may interact with the trusted third party system 114 via a chat session or other online communication or electronic message technique using the client device 118 or mobile device 120. In yet another embodiment, a consumer 184 may register with the system 100 during a communication session via a communication device in communication with the network 102 and associated with the consumer 184. For example, a consumer may place a call, such as a call from a telephone or a mobile device 120 via the network 102 to the trusted third party system 114, and communicate with the trusted third party system 114.

In any instance, a token transaction processing application, such as 136, associated with the trusted third party system 114 can receive certain information from the consumer 184 via the website and/or webpage, online session, communication, electronic message, or call. In the embodiment of FIG. 1, the consumer 184 can provide user identification information, such as 190, and payment account information, such as 192, to the token transaction processing application 136. By way of example, the consumer 184 can provide his or her mobile device number or cell phone number, and a bank account number to the token transaction processing application 136 during the authentication and registration process. User identification information can include, but is not limited to, a mobile phone number, a telephone number, a loyalty number, a customer number, or a unique number identifying the consumer. Payment account information can include, but is not limited to, a bank account number or code, a payment account number or code, a credit card account number or code, a debit card account number or code, a stored value account number or code, a loyalty account number or code, a gift account number or code, a coupon number or code, or any other type of account used to exchange value between two parties. In certain other embodiments, other information may be provided to facilitate registration and/or verification of the consumer's identity, or otherwise to obtain a token including, but not limited to, biometric information, a name, an address, a third party or financial institution name, or an account name or balance. In any instance, the token transaction processing application 136 can communicate via the network 102 with some or all of a mobile device network operator system, such as 122, a financial account system 124, and/or a data store 132 to validate some or all of the received user identification information 190 and payment account information 192.

In the embodiment shown in FIG. 1, the token transaction processing application 136 may communicate with a mobile device network operator system 122 to confirm or otherwise validate a portion of the received user identification information 190 and payment account information 192, such as confirming whether the consumer 184 has a mobile device account 172 and/or whether a mobile device number corresponds with a mobile device account 172 associated with the consumer 184. In other embodiments, other portions of received user identification information 190 and payment account information 192 can be confirmed or otherwise validated by the mobile device network operator system 122.

Furthermore, in the embodiment shown in FIG. 1, the token transaction processing application 136 may communicate with a financial account system 124 to confirm or otherwise validate a portion of the received user identification information 190 and payment account information 192, such as confirming whether the consumer 184 has a payment account 180 and/or whether a payment account number corresponds with a payment account 180 associated with the consumer 184. In other embodiments, other portions of received user identification information 190 and payment account information 192 can be confirmed or otherwise validated by the financial account system 124.

For example, validation of the user identification information 190 and payment account information 192 can include comparing a previously stored mobile phone number and payment account number to the user identification information 190 and payment account information 192. In another example, validation of the user identification information 190 and payment account information 192 can include confirming the consumer 184 is associated with a particular mobile device number corresponding with the user identification information 190, and further confirming the consumer 184 is associated with a particular payment account corresponding with the payment account information 192. In another example, validation of the user identification information 190 and payment account information 192 can include transmitting a message to the consumer 184 via a separate manner, such as via a mobile device 120, and requesting the consumer to provide an indication, such as a return or reply communication, that the consumer has received the message. In yet another example, validation of the user identification information 190 and payment account information 192 can include instructing or otherwise facilitating one or more deposits in the consumer's payment account, and receiving an indication the consumer has confirmed receipt of the one or more deposits and/or deposit amounts.

In any instance, after the token transaction processing application 136 has sufficiently validated the identity of the consumer 184 by way of receipt of, processing, and confirming the user identification information 190 and/or payment account information 192, the token transaction processing application 136 can generate or otherwise provide and transmit a token 188 to the consumer 184 for use in as payment for a purchase of goods and/or services. Generally, the token transaction processing application 136 can generate a unique, random code or number using any code or number generation techniques and/or devices. For example, a set of computer-readable instructions operable for generating a single use, time sensitive code or number can be stored in memory 140 associated with the trusted third party system 114, and the token transaction processing application 136 and/or processor 138 can execute the instructions when needed. The term “single use” herein means the code or number can be used for only a single purchase transaction, after which the code or number will expire. Further the term “time sensitive” herein means the code or number has a limited life, for instance, 30 minutes, after which the code or number will expire. In another example, the token transaction processing application 136 may obtain a token from a predefined set of single use, time sensitive codes or numbers that have been previously generated, and are stored in memory 140 and/or a data store, such as 132. By way of continuing example, the token transaction processing application 136 can randomly generate a single use, time sensitive string of 4 or 6 digits, such as “0423” or “010906,” that is mapped to the consumer's payment account information, such as the consumer's bank account number. In any instance and according to certain embodiments, a token can include, but is not limited to, a unique number for use in a single transaction, a time sensitive code, a numeric string, an alphanumeric string, a single use code, a 2D or 3D bar code, or a unique code. After the token 188 is generated by the token transaction processing application 136, the application 136 and/or processor 138 can also store information associated with the token 188 in memory 140 and/or a data store 132 for subsequent retrieval and/or reference. In certain instances, when a time sensitive token is generated, the token transaction processing application 136, the application 136 and/or processor 138 can determine when the token 188 expires and can store a suitable indication of expiration in memory 140 and/or the data store 132 in the event the expired token is presented to a merchant as payment for goods and/or services.

In one embodiment, a mobile device 120 or other system component may generate or otherwise obtain a token 188 for a transaction. When the mobile device 120 or other system component generates or obtains a token 188, the mobile device 120 or other system component can communicate with the token transaction processing application 136 and/or processor 138 to synchronize or otherwise store information associated with the token 188 in memory 140 at the trusted third party system 114 and/or a data store 132 for subsequent retrieval and/or reference.

In any instance, after the token 188 is generated or otherwise obtained by the token transaction processing application 136, mobile device 120, or other system component, the token 188 can be transmitted to the consumer 184. Example transmissions or communications of the token 188 to the consumer 184 can include, but are not limited to, an electronic message, text, tweet, email, online communication, an online communication via HTTP, an online communication via an online communication protocol, a website and/or webpage posting, voice mail, phone call, mail, or other voice or electronic communication. In many instances, the token 188 may be transmitted to the consumer 184 in text form and/or as electronic data to be stored in a respective memory 154, 162 of the client device 118 and/or mobile device 120. In certain other embodiments, the token 188 may be transmitted to the consumer 184 to be stored in a memory of a contactless device, such as a smart card, fob, or other portable device associated with the consumer 184. In any instance, upon receipt of electronic data at the client device 118, mobile device 120, or any other contactless device, the token 188 and associated electronic data can be encoded, stored, or otherwise input to the respective memory of the client device 118, mobile device 120, or any other contactless device.

In one embodiment, to enhance the security of registration and validation of the consumer's identification as well as transmission of the token 188 to the consumer 184, the token 188 can be sent to the consumer 184 via a separate manner than how the consumer 184 initiated communication with the token transaction processing application 136. For instance, if the consumer 184 originally initiated communication with the token transaction processing application 136 using the client device 118, such as a personal computer, the transaction processing application 136 may send or otherwise transmit the token 188 to the consumer 184 via the mobile phone, such as 120, or another client device associated with the consumer 184. Likewise, if the consumer 184 originally initiated communication with the token transaction processing application 136 using the mobile phone 120, the token transaction processing application 136 may send or otherwise transmit the token 188 to the consumer 184 via the client device 120, such as a personal computer, or another client device associated with the consumer 184. Thus, the term “separate manner” used herein refers to using a different and subsequent communication mode than the original initiated communication mode, regardless of whether the communication modes are made from or on the same device. By way of continuing example, the consumer may register with the token transaction processing application 136 via an app or browser program stored and executed on a mobile device 120, such as a mobile phone, and then receive an email or text via an email account or mobile phone number accessible or otherwise associated with the same mobile device 120.

In any instance, when desired, the consumer 184 can provide, as further described below, the received token 188 to a merchant user 186 and/or a merchant system 104 as payment for a purchase of goods and/or services.

Payment Processes Using a Token and/or Other Information

After the consumer 184 has received the token 188, the consumer 184 may interact with the merchant system 104 to make a payment. Generally, the consumer 184 can interact with at least one of the merchant transaction client devices 106, 108, 110 associated with the merchant system 104 and/or local transaction processing system 112 to make the payment. For example, the consumer 184 can interact with a contactless transaction device 106, a PIN pad 108, and/or a transaction terminal 110. In certain other embodiments, the consumer 184 may interact with another type of merchant transaction client device including, but not limited to, a point of sale (POS) terminal, personal computer, or other telecommunications device to communicate with the merchant system 104.

In any instance, typically one or more payment options may be offered to the consumer 184 at the merchant transaction client device, such as 106, 108, 110. Payment options can include, but are not limited to, a token pay transaction, a token transaction, a credit transaction, a debit transaction, a stored value card payment, a loyalty card payment, a gift card payment, and a coupon redemption or payment. Generally, after a suitable payment option, such as a token pay transaction or token transaction, is selected by the consumer 184 and/or a merchant user, such as 186, the consumer 184 and/or the merchant user 186 can input certain payment information to a merchant transaction client device 106, 108, 110 for processing. In certain instances, a merchant user 186 can input certain payment information directly to a local transaction processing system 112 without use or aid of a merchant transaction client device 106, 108, 110. In any instance, payment information can include any combination of a token, user identification information, and/or payment account information. By way of continuing example, the consumer 184 may provide the token 188 and the user identification information to a merchant transaction client device 106, 108, 110 and/or merchant user 186 as payment during a token transaction. One will recognize that embodiments of the invention are not limited by the token transaction examples provided herein.

In any instance, after receipt of the payment information, the merchant transaction client device 106, 108, 110 and/or local transaction processing system 112 can communicate via the network 102 with a trusted third party system 114 and/or token transaction processing application 136 to process the desired transaction using the payment information. After confirming the payment information, the trusted third party system 114 and/or token transaction processing application 136 can communicate back to the merchant transaction client device 106, 108, 110 and/or local transaction processing system 112, and confirm to the consumer 182 and/or merchant user 184 that the payment information has been accepted, and the desired transaction can be consummated between the consumer 182 and merchant user 184.

### (A) Via Mobile Phone/Contactless Device

In one embodiment, a consumer 184 can use a token, such as 188, stored in memory, such as 162, on a mobile phone, such as 120, or a contactless device, such as a smart card, to make a payment to a merchant. In this example, the consumer 184 can interact with a merchant transaction client device, such as a contactless transaction device 106, associated with a merchant system, such as 104. When the transaction is initiated between the consumer 184 and the merchant system 104, the contactless transaction device 106, for instance, a NFC (near field communication) device can be activated by the merchant system 104 and/or merchant user 186 to accept or otherwise a wireless transmission or transfer of payment information. By manipulating the mobile device 120 or other contactless device adjacent to the contactless transaction device 106, which may be prominently labeled as a token pay transaction component, the consumer 184 can transfer payment information, such as the token 188 and/or other information stored in the memory 162 of the mobile phone 120, or other contactless device, to transfer the payment information including the stored token 188 to the contactless transaction device 106. By way of example, the consumer 184 may be prompted by the contactless transaction device 106 to tap or wave his or her mobile device 120, such as a cell phone, adjacent to the contactless transaction device 106 to facilitate the transfer of payment information from the mobile device 120 to the contactless transaction device 106. In this example, the contactless transaction device 106 can be a NFC device such as a VivoTech VIVO PAY 4500™ or similar model, which can be operated by tapping or otherwise manipulating the mobile phone 120 or other contactless device within a predefined distance from the NFC device.

In one embodiment, a contactless device can be a contactless transaction card. One example of a contactless transaction card is a smart card that can be tapped against or otherwise manipulated adjacent to and within a predefined distance, without contact, of the contactless transaction device, such as 106, which reads information from the contactless transaction card. A smart card can include an embedded chip or memory for storing payment information such as a token, user identification information, and/or payment account information. In another example, a contactless device can be a storage device such as a memory chip embedded in or associated with a fob, a sticker, a telecommunications device, or other device or apparatus used by the consumer 184 to make a payment to a merchant.

### (B) Via Pin Pad

In another embodiment, a consumer 184 can use a token, such as 188, received from the trusted third party system 114 to make a payment to a merchant by inputting the token into a PIN pad. In this example, the consumer 184 can interact with a merchant transaction client device, such as a PIN pad 108, associated with a merchant system, such as 104. When the transaction is initiated between the consumer 184 and the merchant system 104, the PIN pad 108 may provide a payment option to the consumer 184 for a token payment. After inputting a selection to the PIN pad 108, such as by selecting a key or button corresponding with the token pay transaction or token transaction option, the consumer 184 can be prompted to input payment information including the token 188 via a keypad or touch screen associated with the PIN pad 108. By way of example, the consumer 184 may be prompted to enter the token 188 followed by user identification information 190, such as a mobile device or phone number. In this example, the merchant transaction client device 108 can be, for example, a First Data FD-30™ PIN pad or similar model, which can be operated by inputting or touching keys, buttons, or a touch screen associated with the device 108.

### (C) Via Transaction Terminal

In yet another embodiment, a consumer 184 can use a token, such as 188, received from the trusted third party system 114 to make a payment to a merchant by providing the token to the merchant. In this example, the consumer 184 can interact with a merchant operating a merchant transaction client device, such as a transaction terminal 110, or otherwise associated with or operating a local transaction processing system, such as 112, or a merchant system, such as 104. When the transaction is initiated between the consumer 184 and the local transaction processing system 112 or the merchant system 104, the transaction terminal 110 may provide a payment option to the merchant user 186 for a token pay transaction or token transaction. After inputting a selection to the transaction terminal 110 and/or local transaction processing system 112, such as by selecting a key or button corresponding with the token pay transaction or token transaction option, the merchant user 186 can request from the consumer 184 suitable payment information to input to the transaction terminal 110 and/or local transaction processing system 112. After the consumer 184 provides the payment information to the merchant user 186, the merchant user 186 can input the payment information including the token 188 via a keypad or touch screen associated with the transaction terminal 110. In this example, the merchant transaction client device 108 can be, for example, a First Data FD-30™ PIN pad or similar model, and the merchant transaction client device 110 can be, for example, a transaction terminal which can be used in a retail environment with any number of retail point of sale (POS) systems, such as those provided by IBM Corporation, NCR Corporation, and others.

### (D) Via Online

In yet another embodiment, a consumer 184 can use a token, such as 188, received from the trusted third party system 114 to make a payment to an online merchant by providing the token to the online merchant. In this example, the consumer 184 can interact via a client device 118 or a mobile device 120 with a merchant operating a merchant transaction client device, such as a transaction terminal 110, associated with a merchant system, such as 104, and/or local transaction processing system 112. When the transaction is initiated between the consumer 184 and the merchant system 104 and/or local transaction processing system 112, the consumer 184 may be presented with one or more webpages on a hosted website associated with the merchant system 104, and prompted by a webpage and/or merchant system 104 to select a payment option for the transaction, such as a token pay transaction or token transaction. After inputting a selection to the webpage and/or merchant system 104, such as by selecting a key or button corresponding with the token pay transaction or token transaction option, the webpage and/or merchant system 104 can request from the consumer 184 suitable payment information to input for the token transaction. After the consumer 184 provides the payment information to the webpage and/or merchant system 104, the webpage and/or merchant system 104 can process the payment information including the token 188 via the token transaction processing application 134.

### Merchant and System Processing of Token Transaction

In any instance, after the payment information including the token 188 has been received by a merchant system 104 and/or local transaction processing system 112 via merchant client transaction device, such as 106, 108, 110, or via an online webpage and/or website, the merchant system 104 and/or local transaction processing system 112 can process the payment information using the token transaction processing application 134 associated with the merchant system 104 and/or local transaction processing system 112. The token transaction processing application 134 of the merchant system 104 and/or local transaction processing system 112 can communicate via the network 102 with the trusted third party system 114 and associated token transaction processing program 136 to transmit the payment information to the trusted third party system 114 and associated token transaction processing program 136 for further processing.

In the embodiment shown in FIG. 1, the token transaction processing program 136 and/or the trusted third party system 114 can decrypt or otherwise translate certain portions of the received payment information. In one embodiment, the clearinghouse system 116 can decrypt or otherwise translate certain portions of the received payment information to determine whether the received payment information is authentic or otherwise valid for acceptance as a payment. For example, when a token 188 is received by the token transaction processing program 136 and/or the trusted third party system 114, the token 188 can be decrypted or otherwise translated to determine the payment account or other payment information which is used to authorize, clear, and settle the requested payment transaction. By way of continuing example, the token transaction processing program 136 can call to memory 140 and/or a data store 132 to determine whether the token 188 matches a record of a previously registered or otherwise generated token with corresponding payment account or other payment information. In certain embodiments when the token is a time sensitive code, the token transaction processing program 136 can determine whether the token 188 has expired and/or whether a predefined time has elapsed since the token 188 was generated.

In another example, user identification information 190 can be received by the token transaction processing program 136 and/or the trusted third party system 114. By way of continuing example, the token transaction processing program 136 can call to memory 140 and/or a data store 132, or may communicate with a mobile device network operator system, such as 122, or a financial account system, such as 124, to determine whether the user identification information 190 matches a record of the user's identification information, such as matching a mobile device number with the consumer's mobile device account 172, matching a telephone number associated with the consumer's telephone account, or a matching a payment account number associated with the consumer's payment account.

In any instance, after confirming the token 188 has not expired, and a record of the token 188 and/or user identification information 190 can be validated by comparison to information stored memory 140, a data store 132, a mobile device network operator system 122, or financial account system 124, the token transaction processing program 136 can transmit an communication or indication to the token transaction processing program 134 and/or merchant system 104 that the token transaction has been authenticated, validated, or otherwise approved. The token transaction processing program 134, local transaction processing system 112, and/or merchant system 104 can communicate with the originating merchant client transaction device, such as 106, 108, 110, or with the merchant's online webpage and/or website 131 to confirm the token transaction has been authenticated, validated, or otherwise approved, wherein the consumer 184 and/or the merchant user 186 can consummate the purchase of goods and/or services by the consumer 184.

In the meantime, the token transaction processing program 136 and/or trusted third party can transmit a communication or instruction via the network 102 to a clearinghouse system 116 or other account clearing and settlement entity to process a payment of electronic funds or other value associated with token transaction. For example, the communication or instruction from the token transaction processing program 136 can include the corresponding payment account or other payment information from the authenticated, validated, or otherwise approved token transaction as well as at least a monetary or value amount of the token transaction. Using conventional techniques and devices, the clearinghouse system 116 can clear and settle the token transaction as a payment transaction by using at least the payment account and monetary or value amount of the token transaction to debit or otherwise modify information, such as an account balance, in a payment account, such as 148, associated with the consumer 184. In certain instances, the clearinghouse system 116 may be in communication via the network 102 with a financial account system, such as 124, and a communication or instruction from the clearinghouse system 116 can indicate a payment account, such as 180, associated with the consumer 184 for the financial account system 124 to debit or otherwise modify accordingly.

After information such as an account balance of a payment account 148, 180 associated with the consumer 184 has been debited or otherwise modified to reflect the monetary or value amount of the purchase transaction, the clearinghouse system 116 and/or financial account system 124 can communicate with or otherwise send an indication via the network 102 to the trusted third party 114 and/or token transaction processing program 136 that the respective payment account 148, 180 has been debited or otherwise modified, and the payment for the token transaction has been cleared and settled. The token transaction processing program 136 and/or trusted third party system 114 can receive the communication or indication from the clearinghouse system 116 and/or financial account system 124, and in turn, the token transaction processing program 136 or trusted third party system 114 can communicate with or otherwise send an indication via the network 102 to the merchant system 104, local transaction processing system 112, and/or associated token transaction processing application 134 that the payment associated with the token transaction has been cleared and settled.

If, however, the token transaction processing program 136 and/or clearinghouse system 116 determines that a token, such as 188, provided by a consumer 184 has expired, or otherwise determines the token 188 and/or user identification information 190 provided by the consumer 184 cannot be authenticated, validated, or otherwise approved, the token transaction processing program 136 and/or trusted third party 114 can transmit a communication or instruction via the network 102 back to the merchant system 104, local transaction processing system 112, and/or token application processing application 134 to decline or disapprove the requested token transaction. For example, the communication or instruction from the token transaction processing program 136 and/or trusted third party 114 can include a message to a consumer 184 and/or merchant user 186 to decline the requested token transaction. After receipt of the decline or disapproval of the requested token transaction, the consumer 184 and/or merchant user 186 can attempt another token transaction with a different token, or may attempt to make a payment using a different payment type.

Other system and process embodiments in accordance with the invention can include fewer or greater numbers of components and/or process elements, and may incorporate some or all of the functionality described with respect to the system components shown in FIG. 1.

One skilled in the art may recognize the applicability of embodiments of the invention to other environments, contexts, and applications. One will appreciate that components of the system 100 and processes described with respect to FIG. 1 are provided by way of example only. Numerous other operating environments, system architectures, processes, and device configurations are possible. Accordingly, embodiments of the invention should not be construed as being limited to any particular operating environment, system architecture, process, or device configuration.

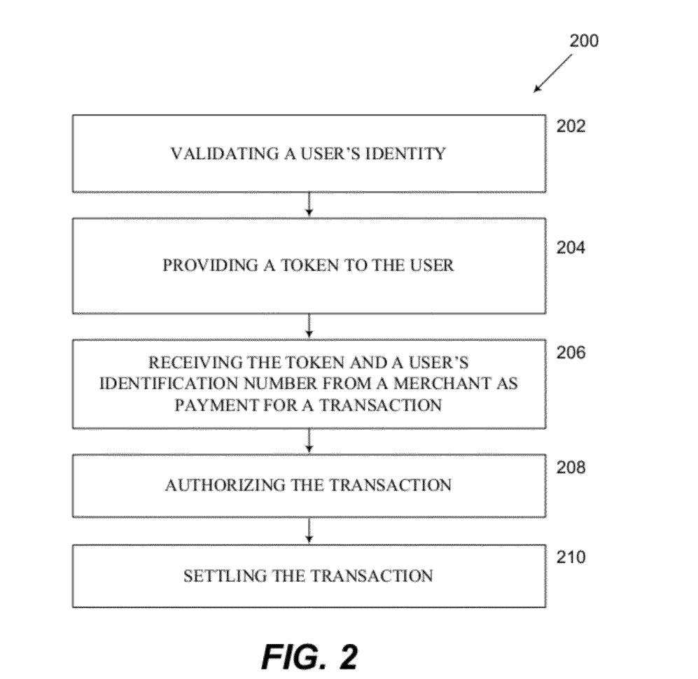

Embodiments of a system, such as 100, can facilitate processing a contactless transaction card. Improvements in contactless transaction card accounting and management, as well as new sources of contactless transaction card revenue, can be achieved by way of implementation of various embodiments of the system 100, data flow 200, and methods described herein. Example methods and processes which can be implemented with the example system 100 and data flow 200, as well as other system and data flow embodiments, are described by reference to FIGS. 2-4.

FIG. 2 illustrates an example method of facilitating a payment transaction using a mobile device according to one embodiment of the invention. The method 200 begins at block 202, in which a user's identity is validated. In the embodiment shown in FIG. 2, user identification information 190 and/or payment account information 192 received from a consumer 184 can be used by a token transaction processing application 136 in FIG. 1 to validate or otherwise authenticate the user's or consumer's identity.

In one aspect of one embodiment, validating a user's identity can include receiving the users identification information and payment account information validating the user identification information and payment account by confirming the user is associated with the user identification information and the payment account, and generating a token to provide to the user for a payment transaction.

In one aspect of one embodiment, validating a user's identity can include receiving an online registration request from the user, transmitting a message to the user to complete the online registration, and receiving an indication the user has completed online registration.

In one aspect of one embodiment, validating a user's identity can include receiving a payment account number of the user, facilitating one or more deposits in the user's payment account, and receiving an indication the user has confirmed receipt of the deposit amounts.

In one aspect of one embodiment, validating a user's identity can include transmitting a message to the user, and receiving an indication the user has received the message

Block 202 is followed by block 204, in which a token is provided to the user. In the embodiment shown in FIG. 2, a token transaction processing application 136, mobile device 120, or other system component can generate or otherwise obtain a token, such as 188, for use by a consumer 184 in a payment transaction. The token transaction processing application 136 can transmit the token 188 to the consumer 184 by, for example, email, text, or online communication.

In one aspect of one embodiment, a token can include, but is not limited to, a unique number for use in a single transaction, a time sensitive code, a numeric string, an alphanumeric string, a single use code, a 2D or 3D bar code, or a unique code.

In one aspect of one embodiment, providing a token to the user can include transmitting the token to the user by at least one of the following: an electronic message, text, tweet, email, online communication, an online communication via HTTP, an online communication via an online communication protocol, a website and/or webpage posting, voice mail, phone call, mail, voice communication, or electronic communication.

In one aspect of one embodiment, providing a token to the user can include storing the token in a data storage device associated with the user.

Block 204 is followed by block 206, in which the token and user's identification information are received from a merchant as payment for a transaction. In the embodiment shown in FIG. 2, the token transaction processing application 136 can receive the token 188 and user's identification information 190 from a merchant, such as merchant system 104 and/or local transaction processing system 112, as payment from a consumer or user for a desired purchase transaction. Typically, the consumer 184 or merchant user 186 provides the token 188 and the user's identification information 190 to either a merchant client transaction device, such as 106, 108, 110, or local transaction processing systems 11; to a merchant user 186 operating a merchant client transaction device, such as 106, 108, 110; or to a website 131 associated with a merchant system 104, and a token transaction processing application 134 associated with the merchant system 104 and/or local transaction processing system 112 can transmit the token 188 and the user's identification information 190 to the token transaction processing application 136 associated with a trusted third party system 114 for further processing.

Block 206 is followed by block 208, in which the transaction is authorized. In the embodiment shown in FIG. 2, the token transaction processing application 136 can authorize the transaction after validating or otherwise processing the token 188 and user identification information 190 from the merchant, such as merchant system 104.

In one aspect of one embodiment, authorizing the transaction can include decrypting or translating the token to obtain the user's payment account information.

Block 208 is followed by block 210, in which the transaction is settled. In the embodiment shown in FIG. 2, the token transaction processing application 136 can settle the purchase transaction by obtaining clearing and settlement from a clearinghouse system, such as 116, and/or from a financial account system, such as 124. Clearing and settling actions by a clearinghouse system, such as 116, and/or from a financial account system, such as 124 can include debiting or otherwise modifying an account balance of a payment account, such as 148 or 180, associated with the user or consumer 184.

After block 210, the method 200 ends.

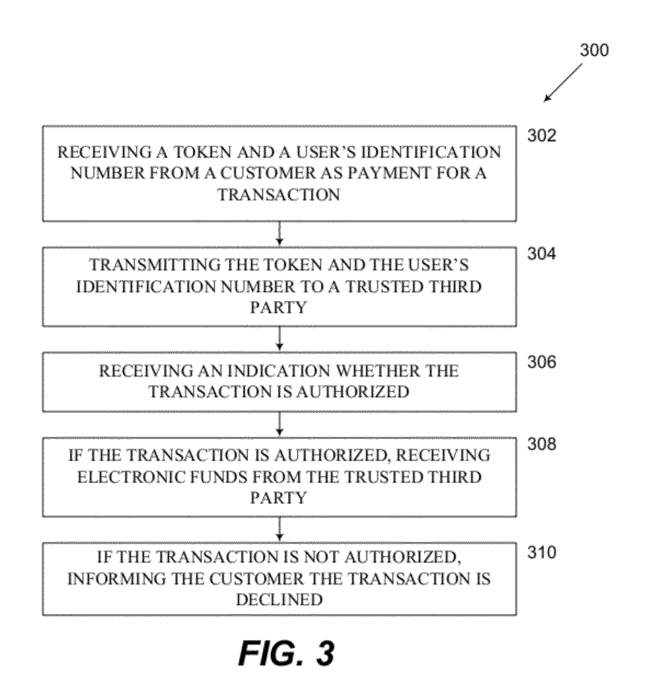

FIG. 3 illustrates an example method of for facilitating a payment transaction according to one embodiment of the invention. The method 300 begins at block 302, in which a token and user identification information are received from a customer as payment for a transaction. In the embodiment shown in FIG. 3, a token 188 and a user identification information 190 can be received by a merchant system 104 and/or local transaction processing system 112 as payment for a transaction with consumer 184. Typically, the token 188 and user identification information 190 can be received by the merchant system 104 and/or local transaction processing system 112 via at least one merchant client transaction device, such as 106, 108, 110, or via a website 131 associated with the merchant system 104. In any instance, a token transaction processing application 134 associated with the merchant system 104 and/or local transaction processing system 112 can receive the token 188 and user identification information 190 from the merchant client transaction device, such as 106, 108, 110 or website 131 for processing.

In one aspect of one embodiment, receiving a token and user identification information from a customer as payment for a transaction can include receiving the customer's token transaction command in a merchant client transaction device, and receiving the customer's input of at least the token to the merchant client transaction device with or without a PIN.

In one aspect of one embodiment, receiving a token and user identification information from a customer as payment for a transaction can include receiving an indication of the customer's manipulation of a data storage device adjacent to a near field communication (NFC) device.

In one aspect of one embodiment, receiving a token and user identification information from a customer as payment for a transaction can include receiving the token from the customer, inputting the token in a payment terminal, and transmitting the token to a trusted third party.

Block 302 is followed by block 304, in which the token and user identification information are transmitted to a trusted third party. In the embodiment shown in FIG. 3, the token transaction processing application 134 can transmit via the network 102 the token 188 and user identification information 190 to a token transaction processing application 136 associated with a trusted third party system 104. The token transaction processing application 136 can authenticate and validate the token 188 and/or user identification information 190 to approve the token transaction, and if approved, a payment account associated with the customer, such as 148 or 180, can be debited or otherwise modified in accordance with the payment transaction. After the transaction has been authorized, the token transaction processing application 136 can transmit an indication via the network 102 to the token transaction processing application 134, merchant system 104 and/or local transaction processing system 112 that the transaction has been authorized.

Block 304 is followed by block 306, in which an indication is received whether the transaction is authorized. In the embodiment shown in FIG. 3, an indication can be received by the token transaction processing application 134, merchant system 104 and/or local transaction processing system 112 that the transaction has been authorized. In turn, the indication can be transmitted to the originating merchant client transaction device 106, 108, 110, or the website 131, where the user can be notified that the transaction is authorized.

Block 306 is followed by block 308, in which if the transaction is authorized, electronic funds are received from the trusted third party. In the embodiment shown in FIG. 3, if the token transaction is authorized, an account associated with the merchant system 104 can receive electronic funds from the trusted third party or on behalf of the trusted third party. For instance, when the token transaction is authorized, an associated payment amount can be cleared and settled by a clearinghouse system, such as 116, or a financial account system, such as 124, for an account associated with the merchant system 104, in which the account can receive a corresponding amount of electronic funds or other value associated with the token transaction.

Block 308 is followed by block 310, in which if the transaction is not authorized, the customer is informed the transaction is declined. In the embodiment shown in FIG. 3, if the token transaction processing application 136 and/or trusted third party 114 cannot authenticate the token 188 and/or user identification information 190, or if the token 188 is expired, an indication can be transmitted by the token transaction processing application 136 and/or trusted third party 144 to the token transaction processing application 134, merchant system 104, and/or local transaction processing system 112 that the transaction has not been authorized or declined. In turn, the indication can be transmitted to the originating merchant client transaction device 106, 108, 110, or the website 131, where the user can be notified that the transaction is not authorized or declined.

After block 310, the method 300 ends.

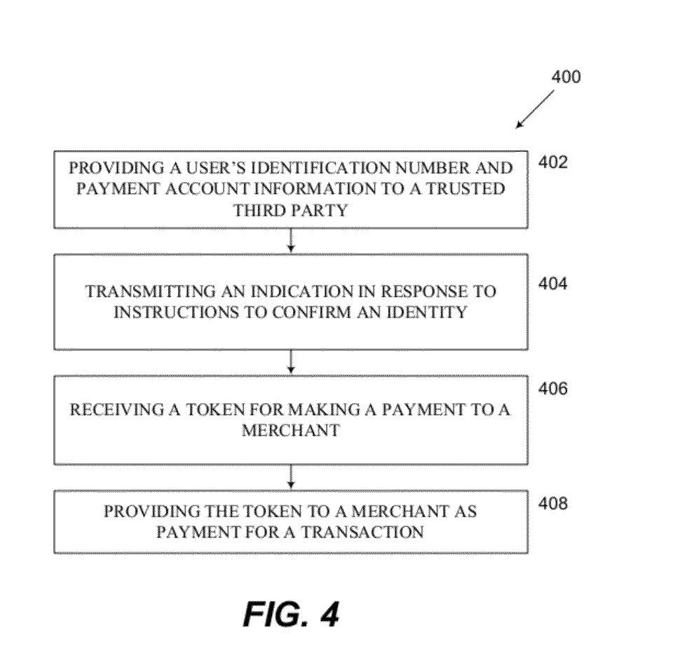

FIG. 4 illustrates an example method for making a payment according to one embodiment of the invention.

This example method 400 begins at block 402, in which user identification information and payment account information are provided to a trusted third party. In the embodiment shown in FIG. 4, a consumer such as 184 can use a client device, such as 118, to provide via the network 102 user identification information 190 and payment account information 192 to a trusted third party, such as 114. For example, a mobile device number and a bank account number can be provided by the consumer 184 via the network 102 to the trusted third party 114, wherein the trusted third party 114 can validate or otherwise authenticate the mobile device number and a bank account number as being associated with the consumer 184. In certain instances, a consumer such as 184 can use a mobile device, such as 120, to provide via the network 102 user identification information 190 and payment account information 192 to a trusted third party, such as 114. In other instances, a consumer such as 184 can use a client device 118 or mobile device 120 to provide user identification information 190 and payment account information 192 via the network 102 to a merchant system, such as 104, which can validate or otherwise authenticate the user identification information 190 and/or payment account information 192.

In one aspect of an embodiment, providing user identification information and payment account information to a trusted third party can include transmitting an online registration request to the trusted third party.

Block 402 is followed by block 404, in which an indication is transmitted in response to instructions to confirm an identity. In the embodiment shown in FIG. 4, the trusted third party 114 can transmit an indication to the consumer 184 via the network 102 to a client device 118 or mobile phone 120 associated with the consumer 184 that the user identification information 190 and/or payment account information 192 has been validated or otherwise authenticated. In certain embodiments, a merchant system 104 and/or local transaction processing system 112 can transmit a communication via the network 102 to the consumer 184 via the client device 118 or mobile device 120 that the identification information 190 and/or payment account information 192 have been validated or otherwise authenticated.

In one aspect of an embodiment, transmitting an indication in response to instructions to confirm an identity can include transmitting a message to the trusted third party in response to receiving a message from the trusted third party.

Block 404 is followed by block 406, in which a token is received for making a payment to a merchant. In the embodiment shown in FIG. 4, a token such as 188 can be transmitted by the trusted third party 114 via the network 102 to the consumer 184, wherein the token 188 can be used to make a payment to a merchant for the purchase of a good and/or service. In certain embodiments, the token 188 can be transmitted in a separate manner than the original communication between the consumer 184 and the trusted third party 114. By way of example, if the consumer 184 used a client device 118 to transmit user identification information 190 and payment account information 192 to the trusted third party for validation or authentication, the trusted third party 114 can transmit the token 188 to the consumer 184 via the network 102 to a mobile device 120 associated with the consumer 184. In certain other embodiments, the merchant system 104 and/or local transaction processing system 112 can transmit a token, such as 188, via the network 102 to the consumer 184, wherein the token 188 can be used to make a payment to a merchant for the purchase of a good and/or service.

In one aspect of an embodiment, a token can include, but is not limited to, a unique number for use in a single transaction, a time sensitive code, a numeric string, an alphanumeric string, a single use code, a 2D or 3D bar code, or a unique code.

In one aspect of an embodiment, receiving a token for making a payment to a merchant can include receiving the token by at least one of the following: an electronic message, text, tweet, email, online communication, an online communication via HTTP, an online communication via an online communication protocol, a website and/or webpage posting, voice mail, phone call, mail, voice communication, or electronic communication.

In one aspect of an embodiment, receiving a token for making a payment to a merchant can include storing the token in a data storage device associated with the user.

Block 406 is followed by block 408, in which the token is provided to a merchant as payment for a transaction. In the embodiment shown in FIG. 4, the consumer 184 can use the token 188 as payment information in a token transaction to purchase a good and/or service from a merchant associated with a merchant system 104 and/or local transaction processing system 112. The consumer 184 and/or merchant user 186 may operate a merchant client transaction device 106, 108, 110 and/or local transaction processing system 112 to provide the payment information including the token, or the consumer 184 may input the payment information including the token 188 to a website 131 associated with the merchant. In any instance, the merchant system 104 and/or local transaction processing system 112 can receive the token 188 and associated payment information from the consumer 184, and process the token transaction as payment for the desired good and/or service.

In one aspect of an embodiment, providing the token to a merchant as payment for a transaction can include entering a token transaction command in a merchant client transaction device, and inputting at least the token to the merchant client transaction device with or without a PIN.

In one aspect of an embodiment, providing the token to a merchant as payment for a transaction can include manipulating a data storage device adjacent to a near field communication (NFC) device.

In one aspect of an embodiment, providing the token to a merchant as payment for a transaction can include providing the token to the merchant to input to a payment terminal for transmission to a trusted third party.

After block 408, the method 400 ends.

Embodiments of the invention are described above with reference to block diagrams and flowchart illustrations of systems, methods, apparatuses and computer program products. It will be understood that some or all of the blocks of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements for performing the specified functions, and program instruction means for performing the specified functions. It will also be understood that some or all of the blocks of the block diagrams and flowchart illustrations, and combinations of blocks in the block diagrams and flowchart illustrations, can be implemented by special purpose hardware-based computer systems that perform the specified functions, elements, or combinations of special purpose hardware and computer instructions.

Additionally, it is to be recognized that, while the invention has been described above in terms of one or more embodiments, it is not limited thereto. Various features and aspects of the above described invention may be used individually or jointly. Although the invention has been described in the context of its implementation in a particular environment and for particular purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every element described and illustrated need be performed. Accordingly, the claims set forth below should be construed in view of the full breadth of the embodiments as disclosed herein.

The claimed invention is:

1. A method for facilitating a payment transaction using a mobile device, comprising:
validating a user's identity;
providing a token to the user;
receiving the token and user identification information from a merchant as payment for a transaction; and
authorizing the transaction.

2. The method of claim 1, wherein validating a user's identity comprises receiving the user identification information and payment account information validating the user identification information and payment account by confirming the user is associated with the user identification information and the payment account, and generating a token to provide to the user for a payment transaction.

3. The method of claim 1, wherein validating a user's identity comprises receiving an online registration request from the user, transmitting a message to the user to complete the online registration, and receiving an indication the user has completed online registration.

4. The method of claim 1, wherein validating a user's identity comprises transmitting a message to the user, and receiving an indication the user has received the message.

5. The method of claim 1, wherein the token comprises: a unique number for use in a single transaction, a time sensitive code, a numeric string, an alphanumeric string, a single use code, a 2D or 3D bar code, or a unique code.

6. The method of claim 1, wherein providing a token to the user comprises transmitting the token to the user by at least one of the following: an electronic message, text, tweet, email, online communication, an online communication via HTTP, an online communication via an online communication protocol, a website and/or webpage posting, voice mail, phone call, mail, voice communication, or electronic communication.

7. The method of claim 1, wherein providing a token to the user comprises storing the token in a data storage device associated with the user.

8. The method of claim 1, wherein authorizing the transaction comprises decrypting or translating the token to obtain the user's payment account information.

9. The method of claim 1, further comprising:
settling the transaction.

10. A system for facilitating a payment transaction using a mobile device, comprising:
at least one data storage device operable to store computer-readable instructions;
at least one computer processor operable to execute the computer-readable instructions; and
a set of computer-readable instructions operable to:
validate a user's identity;
provide a token to the user;
receive the token and user identification information from a merchant as payment for a transaction; and
authorize the transaction.

11. The system of claim 10, wherein the computer-readable instructions operable to validate a user's identity comprise computer-readable instructions operable to:
receive the user identification information and payment account information;
validate the user identification information and payment account number by confirming the user is associated with the user identification information and a payment account; and
generate a token to provide to the user for a payment transaction.

12. The system of claim 10, wherein the computer-readable instructions operable to validate a user's identity comprise computer-readable instructions operable to:
receive an online registration request from the user;
transmit a message to the user to complete the online registration; and
receive an indication the user has completed online registration.

13. The system of claim 10, wherein the computer-readable instructions operable to:
transmit a message to the user; and
receive an indication the user has received the message.

14. The system of claim 10, wherein the token comprises: a unique number for use in a single transaction, a time sensitive code, a numeric string, an alphanumeric string, a single use code, a 2D or 3D bar code, or a unique code.

15. The system of claim 10, wherein the computer-readable instructions operable to provide a token to the user comprise computer-readable instructions operable to:
transmit the token to the user by at least one of the following: an electronic message, text, tweet, email, online communication, an online communication via HTTP, an online communication via an online communication protocol, a website and/or webpage posting, voice mail, phone call, mail, voice communication, or electronic communication.

16. The system of claim 10, wherein the computer-readable instructions operable to provide a token to the user comprise computer-readable instructions operable to store the token in a data storage device associated with the user.

17. The system of claim 10, wherein the computer-readable instructions operable to authorize the transaction comprise computer-readable instructions operable to decrypt or translate the token to obtain the user's payment account.

18. The system of claim 10, wherein the computer-readable instructions are further operable to:
settle the transaction.

19. A method for facilitating a payment transaction, comprising:
receiving a token and a user identification information from a customer as payment for a transaction;
transmitting the token and the user identification information to a trusted third party;
receiving an indication whether the transaction is authorized;
if the transaction is authorized, receiving electronic funds from the trusted third party; and
if the transaction is not authorized, informing the customer the transaction is declined.

20. The method of claim 19, wherein receiving a token and a user identification information from the customer as payment for a transaction comprises receiving the customer's token transaction command in a merchant client transaction device, and receiving the customer's input of at least the token to the merchant client transaction device with or without a PIN.

21. The method of claim 19, wherein receiving a token and a user identification information from a customer as payment for a transaction comprises receiving an indication of the customer's manipulation of a data storage device adjacent to a near field communication (NFC) device.

22. The method of claim 19, wherein receiving a token and a user identification information from a customer as payment for a transaction comprises receiving the token from the customer, inputting the token in a payment terminal, and transmitting the token to a trusted third party.

23. A method for making a payment, the method comprising:
providing user identification information and payment account information to a trusted third party;
transmitting an indication in response to instructions to confirm an identity;
receiving a token for making a payment to a merchant; and
providing the token to a merchant as payment for a transaction.

24. The method of claim 23, wherein providing user identification information and payment account information to a trusted third party comprises transmitting an online registration request to the trusted third party.

25. The method of claim 23, wherein transmitting an indication in response to instructions to confirm an identity comprises transmitting a message to the trusted third party in response to receiving a message from the trusted third party.

26. The method of claim 23, wherein the token comprises: a unique number for use in a single transaction, a time sensitive code, a numeric string, an alphanumeric string, a single use code, a 2D or 3D bar code, or a unique code.

27. The method of claim 23, wherein receiving a token for making a payment to a merchant comprises receiving the token by at least one of the following: an electronic message, text, tweet, email, online communication, an online communication via HTTP, an online communication via an online communication protocol, a website and/or webpage posting, voice mail, phone call, mail, voice communication, or electronic communication.

28. The method of claim 23, wherein receiving a token for making a payment to a merchant comprises storing the token in a data storage device associated with the user.

29. The method of claim 23, wherein providing the token to a merchant as payment for a transaction comprises entering a token transaction command in a merchant client transaction device, and inputting at least the token to the merchant client transaction device with or without a PIN.

30. The method of claim 23, wherein providing the token to a merchant as payment for a transaction comprises manipulating a data storage device adjacent to a near field communication (NFC) device.

31. The method of claim 23, wherein providing the token to a merchant as payment for a transaction comprises providing the token to the merchant to input to a payment terminal for transmission to a trusted third party.
